(19) United States
(12) Patent Application Publication
(10) Pub. No.: US 2007/0031606 A1
(43) Pub. Date: Feb. 8, 2007

(54) APPARATUS AND METHOD FOR FORMING A FILM, PATTERNING METHOD, METHOD FOR MANUFACTURING AN OPTICAL DEVICE AND METHOD FOR MANUFACTURING AN ELECTRONIC DEVICE

(75) Inventor: Takashi MIYAZAWA, Suwa-shi, Nagano-ken (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 11/461,965

(22) Filed: Aug. 2, 2006

(30) Foreign Application Priority Data
Aug. 8, 2005 (JP) 2005-229521

(51) Int. Cl. B05C 5/00; B05D 1/02

(52) U.S. Cl. 427/421.1; 118/313

(57) ABSTRACT

An apparatus for forming a film includes a first nozzle discharging a first chemical species, and a second nozzle discharging a second chemical species.

### BACKGROUND

1. Technical Field

An aspect of the present invention relates to an apparatus and a method for forming a film, a patterning method, a method for manufacturing an optical device and a method for manufacturing an electronic device.

2. Related Art

As a method for forming a fine pattern for manufacturing an electronic device such as a transistor, for example, an ink-jet method and mask patterning are known. In the case of an usual ink-jet method, a discharged droplet needs to be reduced in size so as to obtain high accuracy for patterning. However, there is a limit to reduce the size of the droplet for now. Further, an usual mask patterning tends to have a difficulty especially with patterning on a large substrate because a large mask causes flexure.

WO2003/026359 is an example of related art. According to the related art, a film formation apparatus is provided with a vacuum chamber, a nozzle, a substrate stage and a movement mechanism. The vacuum chamber is capable of being adjusted at a predetermined degree of vacuum. The nozzle is connected to a material supply source while being attached to the vacuum chamber so as to supply a material from the material supply source into the vacuum chamber. The substrate stage is positioned in the vacuum chamber so as to hold and fix a substrate or base member. The movement mechanism can move at least one of the nozzle and the substrate stage so as to control relative positions of the nozzle and the substrate or the base member. A film is thus selectively formed where it is required on a substrate or a base member. In addition, by controlling the distance from the nozzle to the substrate, an area of a film-forming region can be determined appropriately. Another example of related art is Yuan Tseh Lee, Molecular Beam Studies of Elementary Chemical Processes, Nobel lecture, 8 Dec. 1986, p. 320-354.

### SUMMARY

An advantage of an aspect of the invention is to provide a finer pattern than that of related art with an apparatus and a method for forming a film, a patterning method, a method for manufacturing an optical device and a method for manufacturing an electronic device.

The film forming apparatus according to a first aspect of the invention includes a first nozzle discharging a first chemical species and a second nozzle discharging a second chemical species.

Thus discharge of different chemical species from a plurality of nozzles can form films made of different chemical species.

When the first chemical species is chemically reacted with the second chemical species, a product generated from the chemical reaction can form a film without separating the first species and the second species from each other. Alternatively, the first chemical species and the second chemical species can be chemically reacted with a third chemical species, or the first chemical species and the second chemical species can be chemically reacted with other chemical species individually. That is to say, combining appropriate chemical species depending on required films makes it possible to form films having different compositions at the same time.

In addition, it is preferable that the first nozzle and the second nozzle be positioned so as to make at least a part of a stream of the first chemical species discharged from the first nozzle and a part of a stream of the second chemical species discharged from the second nozzle overlap each other.

A chemical reaction is thus induced in an overlapping region where the stream of the first chemical species and the stream of the second chemical species overlap. Accordingly, a minute film is successfully formed in the overlapping region because a cross-section area of the overlapping region is smaller than a cross-section area of the stream of each chemical species.

Further, the film forming apparatus may include a generation part of the first chemical species where a reactive species is generated as the first chemical species.

The reactive species described here is, for example, a chemical species that reacts with the same chemical species or other chemical species by a polymerization or the like. To be specific, it is a radical, an ion radical, ion or a low-valent chemical species, for example.

An example to generate the reactive species is an irradiation of precursor for the reactive species with an electromagnetic wave. As the electromagnetic wave, various waves may be used depending on the first chemical species or a precursor of the first chemical species. The electromagnetic wave here is typified by electric wave, radio wave, light and X-ray such as millimeter wave, submillimeter wave, microwave, infrared radiation, visible light, ultraviolet radiation, vacuum ultraviolet light, or X-ray, for example.

The first chemical species may be generated making use of plasma generated by irradiation of a precursor for the first chemical species with a microwave or a radio wave and so on as the electromagnetic wave to the precursor.

Alternatively, light may be used as the electromagnetic wave. For example, light is led into a generation part of the first chemical species through an optical window or an optical fiber or directly from a light source.

A heating section may be set up in the generation part of the first chemical species so that the reactive species is also generated by heat application to a precursor for the first chemical species.

Further, it is preferable that the film forming apparatus have a chamber in which the first nozzle and the second nozzle are installed and that has an internal pressure adjustable to 1.3×10⁻¹ Pa or less. Thus a chemical species that is hard to be discharged can become easily dischargeable.

Additionally, it is preferable that the first and the second chemical species be discharged as a free jet or in a condition of supersonic molecular jet. By generating the free jet, an energy level such as vibration and rotation of molecule can be in the lowest condition so that a side reaction of a chemical species or a reactive species can be prevented.

The method for forming a film according to a second aspect of the invention includes making at least a part of a stream of a first chemical species discharged from a first nozzle and a part of a stream of a second chemical species discharged from a second nozzle overlap each other so that a chemical reaction in the overlapping region of the first chemical species and the second chemical species is induced and a product generated from the chemical reaction can form a film on a base member.

The chemical reaction is thus induced in an overlapping region where the stream of the first chemical species and the stream of the second chemical species overlap. Accordingly, a minute film is successfully formed in the overlapping region because a cross-section area of the overlapping region is smaller than a cross-section area of the stream of each chemical species.

In addition, it is preferable that at least one of the first and the second chemical species be a reactive species.

The reactive species described here is, for example, a chemical species that reacts with the same chemical species or other chemical species by a polymerization or the like. To be specific, it is a radical, an ion radical, ion or a low-valent chemical species, for example.

An example to generate the reactive species is an irradiation of a precursor for the reactive species with an electromagnetic wave. As the electromagnetic wave, various waves can be used depending on the first chemical species or a precursor of the first chemical species. The electromagnetic wave here is typified by electric wave, radio wave, light and X-ray such as millimeter wave, submillimeter wave, microwave, infrared radiation, visible light, ultraviolet radiation, vacuum ultraviolet light, or X-ray, for example.

For example, the first chemical species may be generated making use of plasma generated by an irradiation of a precursor with microwave or radio wave and so on as the electromagnetic wave to the precursor of the first chemical species.

Alternatively, light may be used as the electromagnetic wave. For example, light is led into a generation part of the first chemical species through an optical window or an optical fiber or directly from a light source.

The reactive species may also be generated by heat application.

The substrate preferably includes a base film made of a material unreactive with the first and the second chemical species on the uppermost surface.

A chemical reaction in a region other than the overlapping region of the first and the second chemical species can be thus prevented.

Additionally, it is preferable that the first and the second chemical species be discharged as free jets. Thereby, an energy level such as vibration and rotation of molecule can be in the lowest condition so that a side reaction of a chemical species or a reactive species can be prevented.

It is preferable that the first chemical species from the first nozzle and the second chemical species from the second nozzle be discharged in a chamber adjusted to a pressure of 1.3×10⁻¹ Pa or less. Thus a chemical species that is hard to be discharged can become easily dischargeable.

The method for forming a film is useful for a combinatorial process as well as for manufacturing a light-emitting diode (LED) array, a thin film transistor (TFT), a sensor, and an optical device and an electric device with the LED array, the TFT and the sensor. The optical apparatus here is, for example, an apparatus having an electrophoretic element and an EL element including dispersion medium dispersed from a liquid crystal element and an electrophoretic particle. The electric device includes, for example, an integrated circuit (IC) card, a cellular phone, a video camera, a personal computer, a head mounted display, a rear or front projector, further, a fax machine with a display function, a finder of a digital camera, a portable TV, a digital signal processing (DSP) device, a personal digital assistance (PDA), a personal organizer, an electronic billboard, and a display for advertising.

The patterning method according to a third aspect of the invention includes making at least a part of a stream of a first chemical species discharged from a first nozzle and a part of a stream of a second chemical species discharged from a second nozzle overlap each other so that a chemical reaction in the overlapping region of the first chemical species and the second chemical species is induced and a pattern for a film made of a product generated from the chemical reaction is formed.

A chemical reaction is thus induced in a region where the stream of the first chemical species and the stream of the second chemical species overlap or cross. Accordingly, a minute film is successfully formed in the overlapping region because the area of the overlapping region is smaller than the area of the stream of each chemical species.

In addition, it is preferable that at least one of the first and the second chemical species be a reactive species.

The reactive species described here is, for example, a chemical species that reacts with the same chemical species or other chemical species by a polymerization or the like. To be specific, it is a radical, an ion radical, ion or a low-valent chemical species, for example.

### BRIEF DESCRIPTION OF THE DRAWINGS

The invention will be described with reference to the accompanying drawings, wherein like numbers reference like elements.

FIG. 1 is a diagram showing a structure of a film-forming apparatus according to the invention.

FIGS. 2A, 2B, 2C and 2D are examples of silicon compounds that are precursors of silylene.

FIGS. 3A and 3B are schematic diagrams showing nozzle positions and a free jet discharged from each nozzle to a substrate.

FIG. 4 is a diagram explaining a polymerization reaction of silylene and silane.

FIGS. 5A, 5B and 5C are diagrams showing steps for manufacturing a TFT.

FIGS. 6A and 6B are diagrams showing an example of a structure in which nozzles and generation parts of chemical species of the film-forming apparatus according to the invention are united.

### DESCRIPTION OF EXEMPLARY EMBODIMENTS

An exemplary embodiment of an aspect of the invention will now be described with reference to the accompanying drawings.

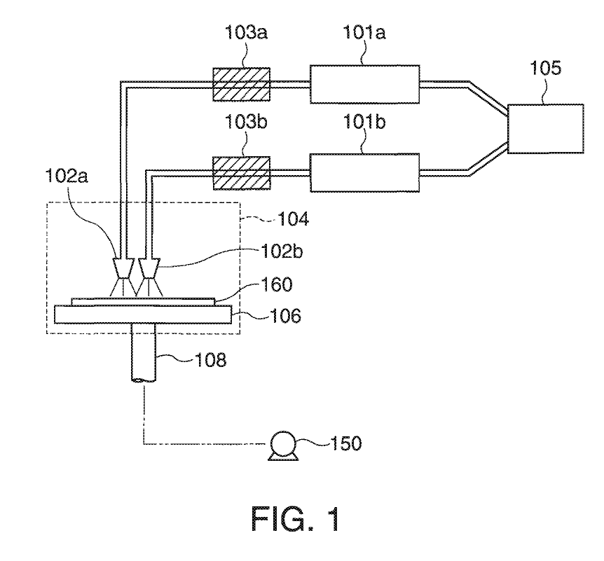

FIG. 1 is a diagram showing a structure of a film-forming apparatus 100 according to the invention.

As shown in the diagram, the film-forming apparatus 100 includes material reservoirs 101a and 101b, nozzles 102a and 102b, heating sections 103a and 103b (generation parts of a first and a second chemical species), a chamber 104, a carrier gas supply source 105, and a substrate stage 106.

The nozzle 102a, the nozzle 102b and the substrate stage 106 are positioned in the chamber 104. As the chamber 104 is connected to a vacuum device 150 via a pipe 108, the degree of vacuum in the chamber 104 is adjustable.

Chemical species or precursors of the chemical species discharged from the nozzles 102a and 102b are stored in the material reservoirs 101a and 101b.

The heating sections 103a and 103b are provided with heating mechanisms. The heating section 103a is positioned between the material reservoir 101a and the nozzle 102a, while the heating section 103b is positioned between the material reservoir 101b and the nozzle 102b. Hereinafter, the heating sections 103a and 103b may be collectively called the heating section 103, and the material reservoirs 101a and 101b may be collectively called the material reservoir 101. By heat application, the heating section 103 generates a reactive species using a material provided from the material reservoir 101 as a precursor for the reactive species.

The reactive species is, for example, a chemical species that reacts with the same chemical species or other chemical species by a polymerization or the like. To be specific, it is radical, ion radical, ion or a low-valent chemical species, for example.

The heating mechanism installed in the heating section 103 is selected in consideration of physical property such as a boiling point and a melting point of a material to be used, chemical property such as a reaction mode, a type of a chemical species to generate, and an amount required to generate a chemical species. The heating device that can be used is, for example, a heating device such as a plate heater, a radiant tube heater, a sheathed heater (a pipe heater), a plug heater, a flange heater, a finned heater, a cartridge heater, a micro heater, a cast-in heater, a band heater, a block heater, a quartz tube heater, a silicone rubber heater, a ribbon heater, a carbon heater, a Ni—Cr heating element, a Fe—Cr heating element, a SiC heating element, and a heating device with a electromagnetic wave generator for high frequency wave or microwave. Alternatively, a reactive gas such as oxygen, chlorine and fluorine or an inert gas such as argon, helium, and nitrogen can be appropriately employed to the heating section 103. Further, the heating section 103 can include a catalyst therein in order to accelerate generation of a chemical species or adjust production efficiency and a reaction temperature.

On the other hand, instead of installing the heating sections 103a and 103b, a reactive species can be generated by electromagnetic wave. In a case of using light as the electromagnetic wave, an optical window can be formed in areas connecting the material reservoir 101a and the nozzle 102a, and the material reservoir 101b and the nozzle 102b. Instead of forming the optical window, a light source such as an optical fiber can be used to lead light.

Alternatively, a mechanism of irradiation of electromagnetic wave such as microwave and radio frequency wave can be provided so as to generate a reactive species by a plasma state generated by irradiation of the microwave or the radio frequency wave, for example.

Each of the nozzles 102a and 102b generates a free jet by discharging a reactive species provided from the heating section 103. The nozzle 102a and the nozzle 102b are positioned so that the free jets discharged from the nozzles overlap at least in a part thereof.

As the discharging mechanism for the nozzles 102a and 102b, for example a mechanism by a mechanical shutter, a continuous system mechanism such as a charge control type and a pressure vibration type, an electromechanical type (so-called piezo-type), and a mechanism by an on-demand system such as an electrothermal type and an electrostatic attraction type can be adopted.

The state of the reactive species discharged from the nozzles 102a and 102b in the chamber 104 can be set by appropriate adjustment of various conditions such as a temperature, a degree of vacuum, a discharging amount, and a time interval of discharging.

To prevent a side reaction of the reactive species, an energy level such as internal vibration and rotation of the reactive species can be in the lowest condition so that the reactive species discharged into the chamber 104 is in the condition of so-called supersonic molecular jet or a free-jet.

If an activation energy is required to initiate a chemical reaction of the reactive species, the energy level such as internal vibration and rotation of the reactive species can be raised to be equal to or more than the level corresponding to the activation energy.

The carrier gas supply source 105 mainly provides an inert gas such as helium, argon, and nitrogen, however, can be also used as a supply source of a reactive gas such as oxygen and a halogen gas in appropriate cases.

In a case where the chemical species itself that is discharged from the nozzle 102a or 102b is stored in the material reservoir 101a or 101b, the material reservoir 101a or 101b itself can be used as a generation part of the chemical species.

In addition, by forming the heating sections 103a and 103b or the like, a chemical species having a high boiling point becomes easy to evaporate.

Next, operation of the film-forming apparatus 100 will be explained.

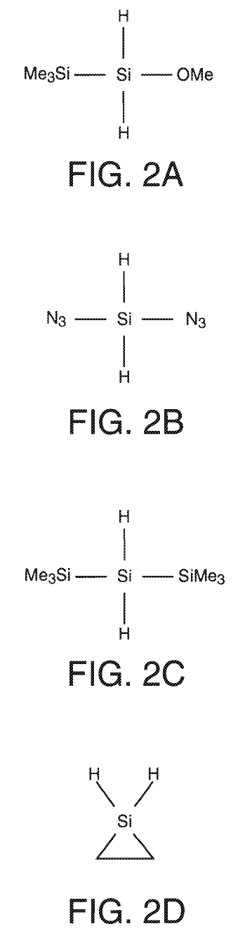

Here, a case to form a semiconductor silicon film on a glass substrate for manufacturing a TFT is cited as an example and will be described. In the material reservoir 101a, a precursor of silylene (SiH₂) that is a low-valent chemical species of silicon is stored. Silicon compounds shown in FIGS. 2A and 2B are examples of the precursors of silylene. In the material reservoir 101b, a precursor of silane (SiH₄) is stored.

When silicon compounds shown in FIGS. 2C and 2D are used, it is preferable that a chemical species such as a reactive species be generated using a light of about 200 nm wavelength.

The precursors in the material reservoirs 101a and 101b are carried by a carrier gas provided from the carrier gas supply source 105, and provided respectively to the heating sections 103a and 103b.

At the heating sections 103a and 103b, the precursors are heated by the heating mechanisms so as to generate a reactive species from the precursors. Here, silylene (SiH₂) is generated as the reactive species at the heating section 103a. On the other hand, silane (SiH₄) stored in the material reservoir 101b is used as it is. Therefore, the heat application at the heating section 103b may not be necessary.

Silylene and silane provided from the heating sections 103a and 103b are carried by the carrier gas, and discharged as a free jet from each of the nozzles 102a and 102b.

It is preferable that the pressure in the chamber 104 be adjusted to a high vacuum atmosphere such as 10⁻³ torr (1.33322×10⁻¹ Pa) or less, or even more favorably at 10⁻⁵ torr (1.33322×10⁻³ Pa) or less. When the vacuum atmosphere is at 10⁻³ torr or less, even a material that is hard to be discharged can become easily dischargeable. Further, when the vacuum atmosphere is at 10⁻⁵ torr or less, even more materials can be discharged, and also the material discharged is easy to evaporate to be like a molecular beam. Therefore, when the chamber 104 is in a high vacuum state, a free jet tends to be generated.

The free jet discharged is on a substrate 160 fixed on the substrate stage 106.

The substrate 160 is a glass substrate. However, a silicon nitride film (SiN) is formed in advance on the surface where the silylene and silane are discharged. This is to prevent a chemical reaction between silylene and an OH group in a region outside of the overlapping region of silylene and silane because a typical glass substrate has an OH group bared on the uppermost surface thereof.

The silicon nitride film can be formed by chemical vapor deposition (CVD). Specifically, silane (SiH₄) and ammonia (NH₃) are blended in an appropriate ratio to add to a hydrogen-based carrier gas. Then, a species such as radical and ion generated from a catalysis or a pyrolysis reaction caused by a heat catalyst is deposited on the glass substrate so as to form a film.

Unreactive with silylene, an organic material such as a normal polyethylene and a normal polystyrene can be used to form a base film on the glass substrate.

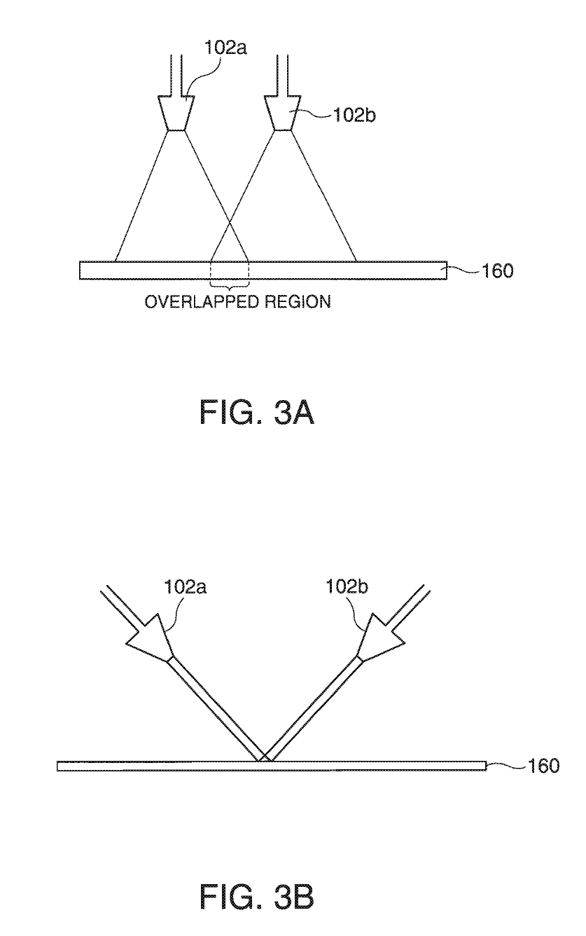

FIG. 3A is a schematic diagram showing each free jet discharged from the nozzles 102a and 102b onto the substrate 160. As shown in the diagram, each free jet discharged from the nozzles 102a and 102b onto the substrate 160 has a predetermined area. The nozzles 102a and 102b are positioned so that the free jets discharged from the nozzles overlap each other on the substrate 160.

Alternatively, the nozzles 102a and 102b can be positioned as shown in FIG. 3B.

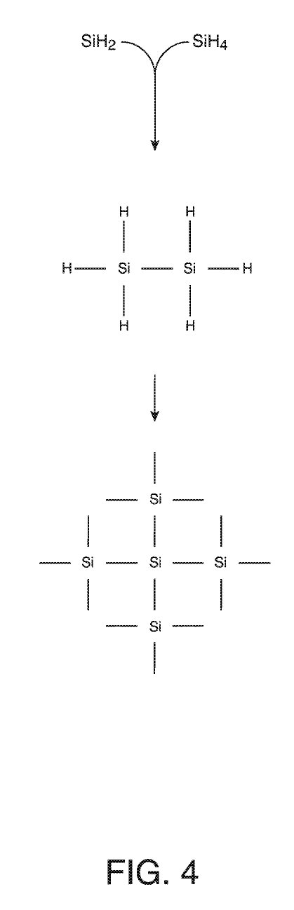

On the substrate 160, a polymerization reaction of silylene and silane are induced in the overlapping region as shown in FIG. 4. As a result, a silicon semiconductor film is formed in and near the overlapping region on the substrate 160. Since the overlapping region is smaller than the area of the stream of each free jet, a minute film smaller than the area of the stream is successfully formed in the overlapping region.

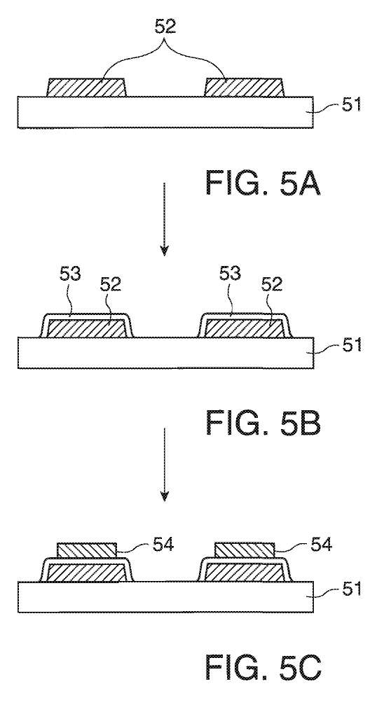

FIGS. 5A, 5B and 5C are diagrams showing steps for manufacturing a TFT. As shown in FIG. 5A, a silicon semiconductor film 52 is formed on a glass substrate 51 according to the method above. Then, as shown in FIG. 5B, SiO₂ is deposited on the silicon semiconductor 52 by CVD with a prescribed silicon compound so as to form a gate insulating film 53. Further, as shown in FIG. 5C, a gate electrode 54 is formed on the gate insulating film 53. Thereafter, a TFT is obtained by implementing a known-process for manufacturing a transistor.

Although a film-forming process to form a silicon semiconductor film for manufacturing a TFT is exemplified here, the film-forming apparatus of the invention is applicable to forming various films such as an insulator, a semiconductor, a conductor and a super-conductive material.

In addition, the film-forming apparatus of the invention is also effective for a combinatorial process. A plurality of films formed by different film-forming conditions can be formed in a plurality of regions on a substrate. For example, adjusting conditions such as a pressure of a carrier gas and a reactive gas, and a degree of pressure reduction in a chamber makes it possible to form a plurality of films having different film-forming conditions at the same time.

Further, another preferred example of the combination of chemical species or precursors for chemical species used for the film-forming apparatus of the invention is a combination of dialkylzinc (ZnR₂) and oxygen (O₂). By the chemical combination of dialkylzinc (ZnR₂) and oxygen (O₂), ZnO is formed in an overlapping region and then, for example, a luminescent layer for a LED array is formed.

If trimethylgallium (Me₃Ga) and ammonia (NH₃) are used, gallium nitride (GaN) is formed in the overlapping region.

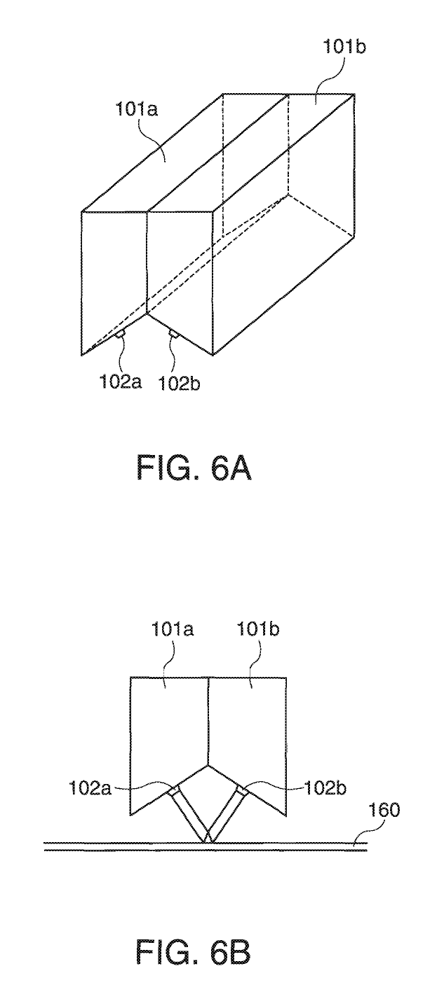

The material reservoirs 101a and 101b (or the heating sections 103a and 103b) and the nozzles 102a and 102b can be united so as to be an apparatus shown in FIGS. 6A and 6B. FIG. 6A is a perspective view of the apparatus, and FIG. 6B is a diagram showing nozzle positions and each free jet discharged from the nozzles onto a substrate.

What is claimed is:

1. An apparatus for forming a film, comprising:
a first nozzle discharging a first chemical species; and
a second nozzle discharging a second chemical species.

2. The apparatus for forming a film according to claim 1,
the first nozzle and the second nozzle being positioned so as to make at least a part of a stream of the first chemical species discharged from the first nozzle and a part of a stream of the second chemical species discharged from the second nozzle overlap each other.

3. The apparatus for forming a film according to claim 1
further comprising
a generation part to generate a reactive species as the first chemical species.

4. The apparatus for forming a film according to claim 1,
an electromagnetic wave being applied to the generation part of the first chemical species.

5. The apparatus for forming a film according to claim 1,
the generation part of the first chemical species including a heating section.

6. The apparatus for forming a film according to claim 1,
further comprising:
a chamber in which the first nozzle and the second nozzle are installed and that has an internal pressure adjustable to 1.3×10⁻¹ Pa or less.

7. The apparatus for forming a film according to claim 1,
each of the first chemical species and the second chemical species being discharged as a free jet.

8. A method for forming a film, comprising:
forming a film on a base member, the film being made of a product generated by a chemical reaction induced by making at least a part of a stream of a first chemical species discharged from a first nozzle and a part of a stream of a second chemical species discharged from a second nozzle overlap each other.

9. The method for forming a film according to claim 8,
at least one of the first chemical species and the second chemical species being a reactive species.

10. The method for forming a film according to claim 9,
the reactive species being generated by an irradiation of a precursor with an electromagnetic wave.

11. The method for forming a film according to claim 9,
the reactive species being generated by a heat application to a precursor.

12. The method for forming a film according to claim 8,
the base member including a base film that is made of a material unreactive with the first chemical species and the second chemical species and that is formed on an uppermost surface of a substrate.

13. The method for forming a film according to claim 8,
each of the first chemical species and the second chemical species being discharged as a free jet.

14. The method for forming a film according to claim 8,
the first chemical species from the first nozzle and the second chemical species from the second nozzle being discharged in a chamber adjusted to a pressure of 1.3×10⁻¹ Pa or less.

15. A patterning method, comprising
forming a pattern of film made of a product generated from a chemical reaction induced by making at least a part of a stream of a first chemical species discharged from a first nozzle and a part of a stream of a second chemical species discharged from a second nozzle overlap each other.

16. The patterning method according to claim 15,
at least one of the first chemical species and the second species being a reactive species.

17. A method for manufacturing an optical device using the method for forming a film according to claim 8.

18. A method for manufacturing an electronic device using the method for forming a film according to claim 8.
